(19) United States
(12) Patent Application Publication
(10) Pub. No.: US 2012/0179750 A1
(43) Pub. Date: Jul. 12, 2012

(54) METHOD AND SYSTEM FOR COORDINATING PERSONNEL FOR AN EVENT

(76) Inventor: Prasad Gollapalli, Reston, VA (US)

(21) Appl. No.: 12/987,144

(22) Filed: Jan. 9, 2011

(51) Int. Cl. G06F 15/16

(52) U.S. Cl. 709/204

(57) ABSTRACT

The present invention provides a method and system for coordinating personnel for an event. The method and system, operative across one or more computing platforms includes electronically receiving, at a central processing device, event data relating to an event, the event data including a request for at least one member to participate in the event. The method and system further includes determining a first set of members relating to the event and providing electronic communication to at least one of the members of the first set of members regarding the event, including a request for participation in the event. Thereby, the method and system includes electronically managing, at the central processing device, the event data including managing member requests for the event.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to the event coordination and more specifically to matching or partnering performers with performance events.

### BACKGROUND OF THE INVENTION

There are current problems with techniques for coordinating performance events, such as music performances, e.g. gigs. Professional work is first come first serve basis (usually). For example, when musician A is looking for a guitar player to play in his gig for tonight, he will take the first guitar player he could find as he doesn't want to perform the gig without a guitar player. Musician B who is a guitar player, is looking for work for tonight and if he contacts musician A right when Musician A is looking for a player, Musician B is most likely to get the gig. But, if he contacted musician A either few days before or after musician A found someone, musician B will miss the gig. In other words, a musician can't wait for a long time before booking someone for a gig. It is hard to know when that short window of opportunity to play in a gig opens up and when it closes unless a musician is constantly in touch with all the other musicians and have a system that tells him instantaneously when gigs open up.

There is no common place where all musicians place their gig (or work) requests and all the musicians who are looking for players could post their gigs in that common place, then only it is easier to ideally match the supply and demand of gigs with professionals.

Another problem with performers is expanding his professional network. One way is to meet other musicians in person and have known musician friends endorse his work and always look for to make connections. Since professional connection between two musicians is only formed when: they perform a gig together or when one musician sees other at a performance; or when one musician is endorsed by a trusted friend of another musician, it is hard to easily expand the professional network.

Another problem for musicians is to keep track of skills and professional levels of the network. It is hard to store information such as skills set (drums, vocal, guitar, bass etc) or professional level (entry, mid-level, professional, country, jazz, hip hop etc) along with the contact details of a contact in phones, outlook and emails. The problem here is not storing but being able to quickly search for a specific type of a person. Say, you are looking for a professional guitar player whom you trust (or at least comfortable to play with) to play in a rock & roll gig. You can't search easily in an email contact system or phone contact system.

Another problem with existing techniques of calling each other for gigs is delay or held up communications. Based on the traveling and uncertainty of regular contact times for musicians, it is difficult to forward communications between other musicians in a timely manner.

Another problem is the quality mismatch of professionals: Most of the professionals think big about their skills but others may not agree. This would cause a disparity on the generic job sites such as an online advertising listing service. If musician A is looking for a guitar player to play in his gig and posts a message on the listing service where anyone could see this message and respond to the message, he is limited in his ability to know if the responding musicians are a right fit with his band or gig.

Another problem is too many matches for a Gig or Player. Suppose musician A is looking for a guitar player to play in his gig for tonight and gets musician P, Q, R, S, T interested to play in the gig. But, musician A selects musician P for the gig. Now, musician A has to send messages to the rest of the musicians—Q, R, S, T that they won't be selected for the gig. There is no simple way to notify other interested musicians when the gig is not longer available. Similarly, if musician A is looking for a gig for tonight and he gets 5 responses with gig offers and he chooses one. Now, he has to send separate messages to the other 4 responses mentioning that he found some other gig. Otherwise, those 4 gig owners will be in a limbo waiting for musician A.

Similarly, problems arise with too many back and forth messages: suppose musician A sends a text message (preferred method by the musicians as they are on the go all the time) looking for a player to play in his gig and it is hard for him to send all the details of the gig such as where is the gig, how much it will pay, who else is playing, where to park and how early they should be there, what genre and songs are played in the gig etc. in the text message. It is hard for the musician A to send all this information in one text message, he usually chooses to send the most important info in the first text message. But, for the other musicians, they want to find out all the information before signing up for the gig. So, those interested musicians will ask for additional information. Now, musician A has to send many separate text messages. This gets exponential when musician A is looking for more than one musician to play in his gig.

Musicians are on the road all the time. The very nature of the work of musician demands that the musician is travelling and playing most of the time. That means, the musician may not have internet or phone access (when a musician is playing, he won't be able to talk or text on the phone) for most part of any given day. This makes it harder for other musicians to reach a musician to check if he is free or booked for a given date.

As professional musicians they have to file for taxes every year and have to report the income they made from the gigs that they played in that year. Since the gigs are signed up from different sources and cash is usually the payment method, it is hard to keep track of all the gigs that the musician played in a year. Plus, they also have to get the 1099 forms from the bars or venues that paid for the gigs. These venues also require a traceable proof to issue 1099 forms.

As such, there exists a need for an improved system for coordinating personnel for an event.

### SUMMARY OF THE INVENTION

The present invention provides a method and system for coordinating personnel for an event. The method and system, operative across one or more computing platforms includes electronically receiving, at a central processing device, event data relating to an event, the event data including a request for at least one member to participate in the event. The method and system further includes determining a first set of members relating to the event and providing electronic communication to at least one of the members of the first set of members regarding the event, including a request for participation in the event. Thereby, the method and system includes electronically managing, at the central processing device, the event data including managing member requests for the event.

The present method and system is a computerized method and/or a processing system. The processing operations may be performed on a central processing device allowing for user access via networked connections. The method and system may include local processing operations facilitating the network interconnectivity, as well as the communication between multiple processing components. In one embodiment, the present method and system can operate across multiple wireless processing devices, such as mobile or smart phones or computers via one or more local applications accessing a centrally disposed processing platform.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a computing environment hosting system for coordinating personnel for an event;

FIG. 2 illustrates a block diagram of one embodiment of a processing device for coordinating personnel for an event;

FIG. 3 illustrates a flowchart of the steps of one embodiment of a method for coordinating personnel for an event;

FIG. 4 illustrates a representative data structure for member data;

FIG. 5 illustrates a graphical representation of a trust network;

FIG. 6 illustrates a flowchart of the steps of one embodiment of a method coordinating musicians for a musical event; and

FIGS. 7-18 provide sample screen shots of various embodiments of a software application providing the coordinating of personnel for an event.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

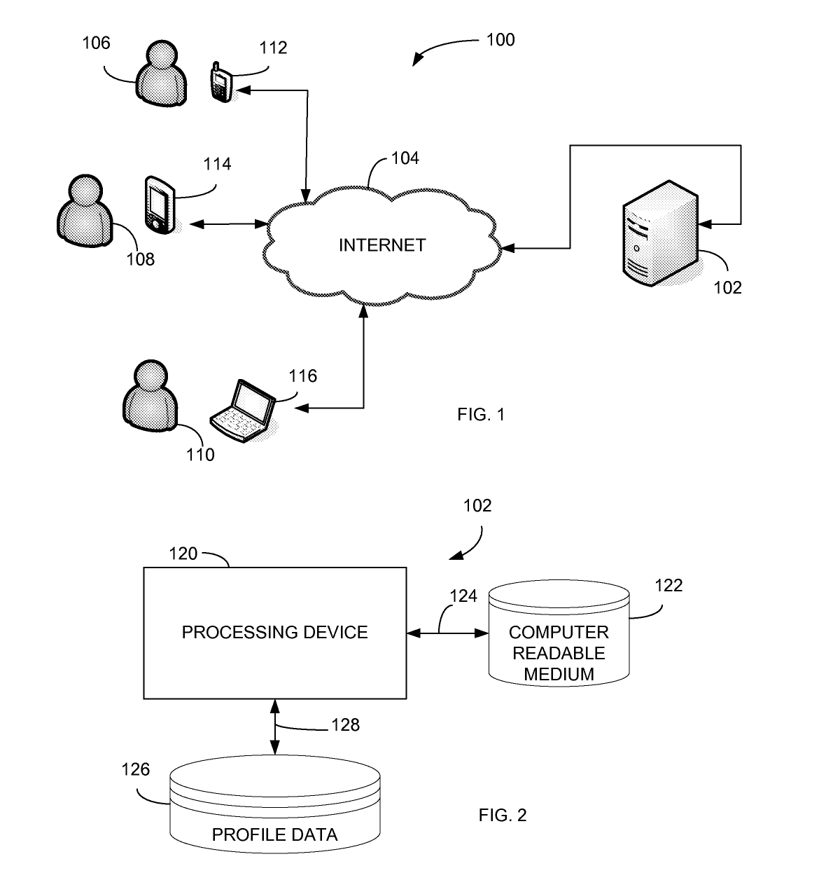

FIG. 1 illustrates one embodiment of a system 100 allowing for the execution of operations relating to the coordination of personnel for an event. The system 100 includes a coordinating server 102 accessible via a network 104, such as the Internet. The system further includes users 106, 108 and 110 (collectively referred to as 106-110), having computing devices 112, 114 and 116 (collectively referred to as 112-116).

In this embodiment, the server 102 may be one or more processing devices capable of executing executable instructions. The server 102 includes processing operations for performing operations thereon, where instructions are coordinated with and can be in response to user commands received across the network 104.

The users 106-110 may be any suitable type of users, including for example, but not limited to, musicians, artists, performers, actors, managers, promoters, business owners, etc. The computing devices 112-116 may be any suitable type of computing device operative to connect to the network 104, either directly or indirectly, for communication with the server 102. By way of specific illustration and not expressly limiting in nature, FIG. 1 illustrates device 112 as a mobile telephone, device 114 as a smart phone or other type of tablet computing device and device 116 as a computer, such as a laptop or a desktop computing device.

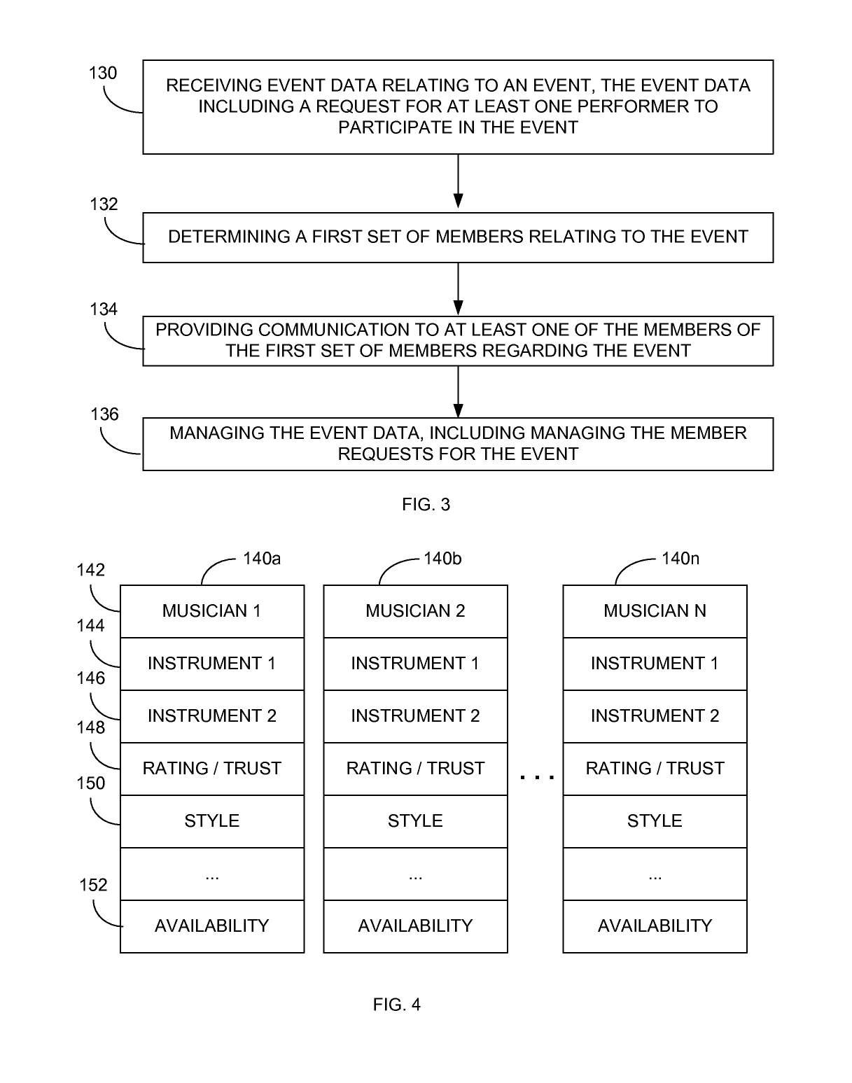

The sake of brevity, the operations of the system 100 are described in further detail below, including but not limited to, the flowcharts of FIGS. 3 and 6. For example, the processing system may be back-end computer processing operations with an interface accessible via a smart-phone application, whereby a user enters information via the mobile device, the information is managed and processed on the processing device and provides the data output to a visual interface on the mobile device.

Relative to the processing device 102 of FIG. 1, FIG. 2 illustrates a further embodiment of one implementation of the server 102. The server 102 includes a processing device 120 in operative communication with a computer readable medium 122 having executable instructions 124 stored thereon. The processing device 120 further communicates with a profile data storage device 126 for the storage of profile information and the performance of operations therewith.

The processing device, 122, in response to receipt of the executable instructions, is operative to perform the processing operations providing for the coordinating of personnel for an event. Similar to FIG. 1, for the sake of brevity, the operations of the processing device 102 are described in further detail below, including but not limited to the flowcharts of FIGS. 3 and 6.

FIG. 3 illustrates a flowchart of the steps of one embodiment of a method for coordinating personnel for an event. The method begins, step 130, by receiving event data relating to an event, the event data including a request for at least one performer to participate in the event. Relative to FIG. 1, one of the users 106-110 may activate a local application on the corresponding computing device 112-116, to enter the event data. This event data may include information such as the name of a performance, e.g. gig, and help that is needed in conducting the performance. For example, suppose a drummer in the user's band is unavailable, the event data can include the name of the event, the location, the type of music being played, the pay, and the type of musician needed to fill in.

In the system of FIG. 1, the user enters this information via the mobile device, whereupon it is transmitted to the server 102 across the network 104. Transmission details for sending and receiving mobile communication data are well known in the art and have been omitted for brevity purposes only. The processing device 120 of FIG. 1, in response to executable instructions 124 from the computer readable medium 122 receives the data.

In the flowchart of FIG. 3, a next step, step 132, is determining a first set of members relating to the event. With respect to FIG. 2, the processing device 120 is operative to utilize the event data and access profile data 128 from the profile database 126.

For the illustration purposes, FIG. 4 represents one embodiment of data structures relating to profile data. The profile data 140a includes data field musician 142, instrument one 144, instrument two 146, rating/trust level 148, style 150 and availability 152. It is recognized that the noted data fields are merely exemplary data fields and any number of suitable data fields may be utilized. For each member, being a person or entity having an account with the server 102, there may be profile data, is illustrated by data structures 140b and 140n, where n is any suitable number.

The profile data 140 includes information about the member or artists and is thus usable by the processing device 120 for performing the determination step 132 of FIG. 3. Various sorting and data matching techniques may be utilized to determine the first set of members. For instance, if the event data includes looking for users having availability to play a particular instrument and the user has a rating or a trust value above a threshold amount, the person can be added to the set of members. The trust value is described in further detail below.

With respect to FIG. 3, a next step in the method is providing communication to one or members of the first set regarding the event. In one embodiment, this notification may include push technology pushing a communication to the user. For instance, the user may have set a preference for means of being contacted, such as by way of example requesting a text message sent to a particular number, or another example being an electronic mail message.

The communication may include event information itself or can in another embodiment including a notification for the user to thus access the server 102 to access the event information. In the example of the user running a smart phone application, the user may receive a text message indicating that event data is available. The user can launch a smart phone application that accesses the server, provides log in or other verification information and then provides the event information to the user via the smart phone.

The user can be presented with an option to accept or join the event, essentially pledging to be available to participate. The user can respond via the smart phone application, in this embodiment, such that the processing device 120 updates the event data to indicate that a personnel demand has been met.

With respect to FIG. 3, another step is the managing the event data, including managing the member requests for the event. This step includes processing operations by the processing device. Where a user has accepted the offer to play or otherwise perform, the event data is updated to indicate there is no longer a need for a performer. Managing the event data can include updating the available display information so that when another user logs in, that user is then notified that the event is no longer in need of a performer. Similar to other notifications, this can also be a push event from the server 102 to provide notifications to the user directly.

Thereby, in this embodiment of the method of FIG. 3, the method provides for coordinating personnel for the event. Additional embodiments can provide for other facets of the coordination of personnel, including for example culling the first set of members based on exclusionary factors. The exclusionary factors can be any number of factors that reduce the number of candidates for the event, and hence do not include or otherwise notify them of the event opportunity. For example, members may be culled by a particular need, such as if the event opening is looking for a guitar player, a keyboardist can be readily eliminated. In another example, if the event needs someone in Washington, D.C. today, if would not be beneficial to include members currently in California, so the culling can be geographic in nature.

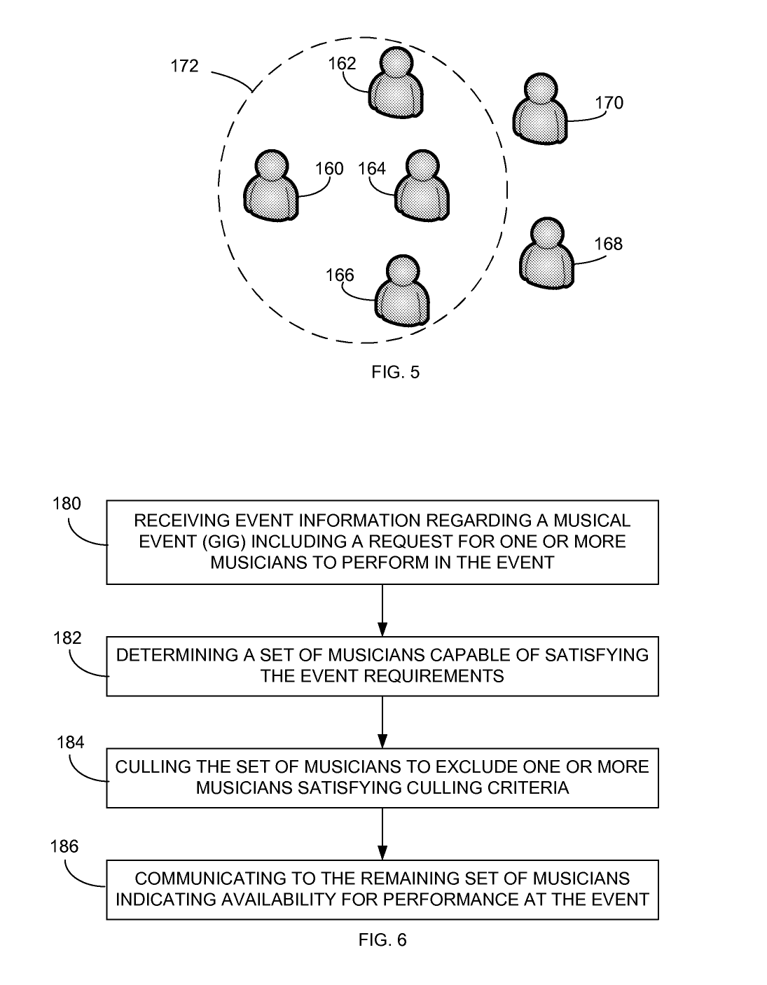

Another culling factor is a trust network. FIG. 5 illustrates an example of a trust network As used herein, a trust network can refer to any number of factors relating to the ability to trust or rely on another member or artist, including factors for actual knowledge of another member or artist, knowledge of someone who knows or otherwise vouches for an artist, as well as the rating or skill level of a particular artist. Members 160-170 may or may not have accounts with the server 102 of FIG. 1. Regardless, the members may have information associated with them in the server, such as profile data. Part of that profile data can be ranking or trust factors associated with users. Trust factors may be similar to a social networking function, where a user can indicate a trust level between different users. For example, suppose user 160 knows and has performed with users 162 and 164. User 160 likes the skill level of users 162 and 164 and trusts to play with them again, user 160 can indicate a trust level.

Similar to social network, if user 164 has a trust level with user 166, user 160 may rely on that trust level to include him in his trust circle. By comparison, user 160 (and maybe by extension users 162, 164 and 166) does not know the skill level and/or do not yet trust users 168 or 170, or could have performed with them and did not prefer their skill or trust their attendance. Then, the circle of trust 172 of FIG. 5 illustrates user 160 having a level of trust with users 162, 164 and 166 but not with users 168 and 170. As such, when user 160 requests an event, the member list that might originally contain all the members of FIG. 5, it can be culled to exclude users 168 and 170.

FIG. 6 illustrates a flowchart of another embodiment, wherein the embodiment relates to the coordinate of musician for a musical event, also known as a “gig.” Similar to the flowchart of FIG. 3, the operations of this methodology may be performed using the system 100 of FIG. 1 and may be performed by the processing device 120 in response to executable instructions 124 of FIG. 2.

In this embodiment, a first step, step 180, is receiving event information regarding a musical event, gig, including a request for one or more musicians to perform in the event. This event data can include information such as when the event is going to be held, what type of musician is needed, the musical style, the pay, etc.

In a next step, step 182, the method includes determining a set of musicians capable of satisfying the event requirements. This step may be similar to the operations described above regarding step 132 of FIG. 3. Moreover, similar to step 134, the next step of this embodiment is culling the set of musicians to exclude one or more musicians satisfying culling criteria. These culling criteria can include the specifics regarding the event, the trust factor, a skill factor, or any other suitable criteria.

In this embodiment, a next step, step 186, is communicating to the remaining set of musicians indicating availability for performance at the event. This may be a push technique sending event information to the users. This may be a partial push technique sending a notification to the user to access the server for more information. Other techniques within the scope of the art are further envisioned. Therefore, in this embodiment, the method is complete.

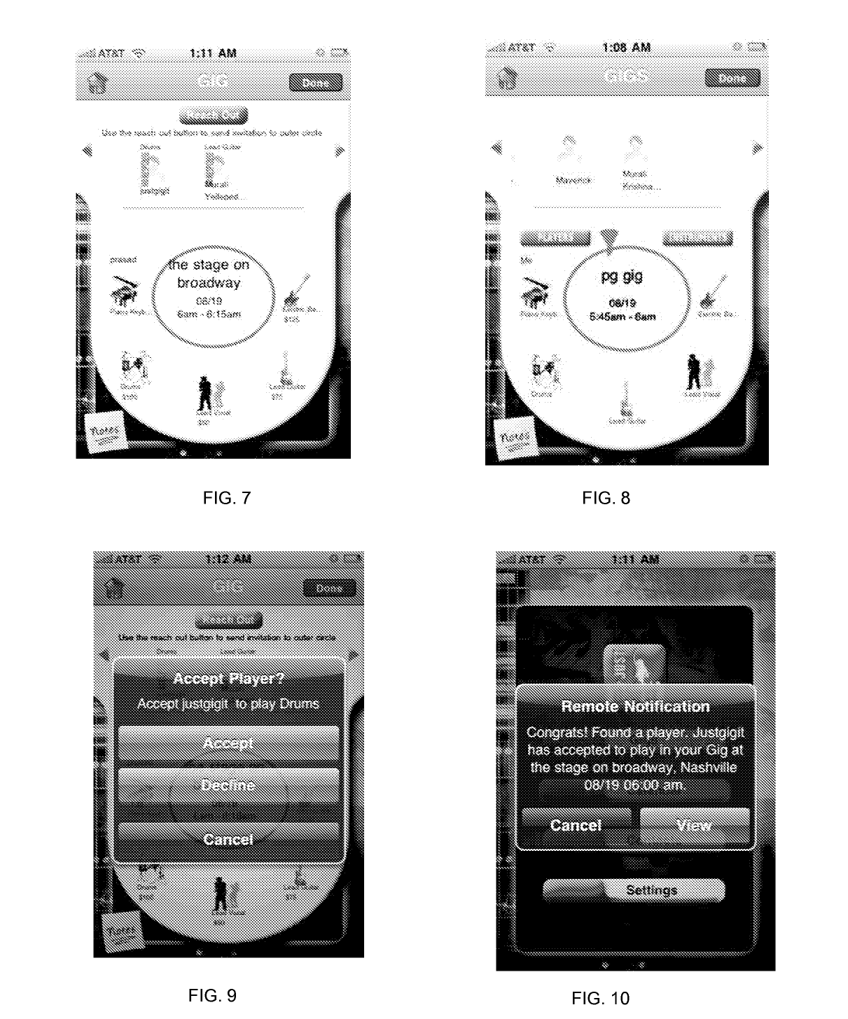

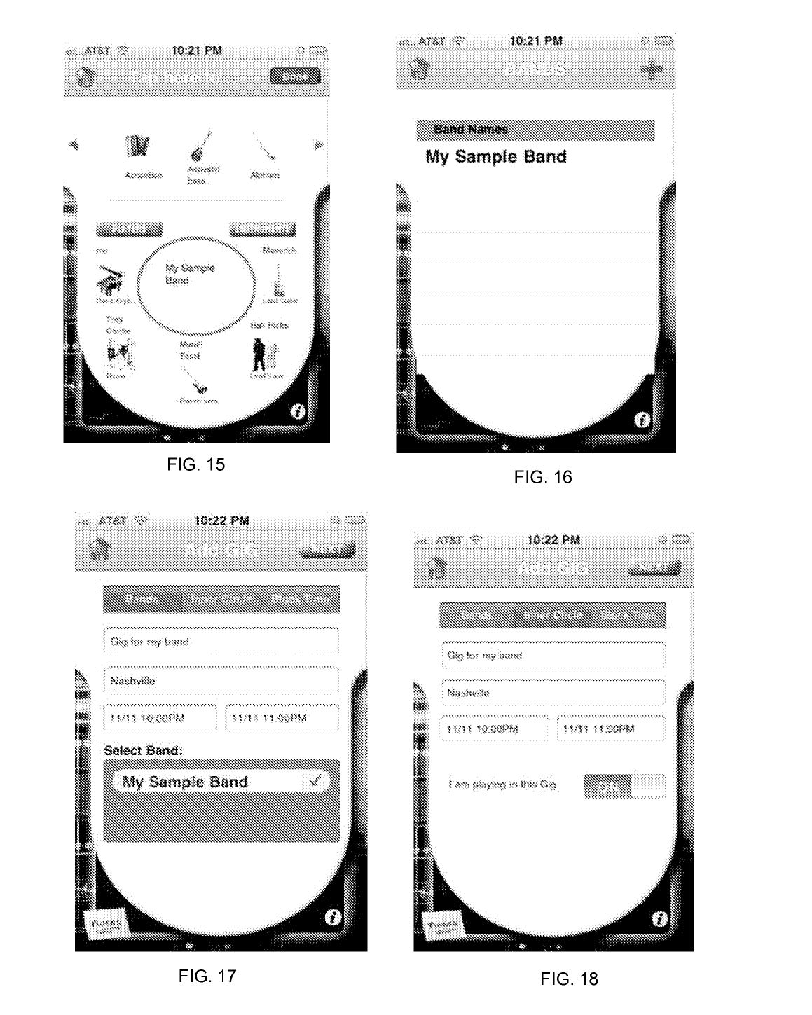

As described above, one embodiment includes communicating interfacing between a user on a mobile or remote device communicating with a server via a network. One example, not expressly limited to this example, is the utilization of an application on a smart phone or tablet computing device. FIGS. 7-18 illustrate representative screenshots from a smart phone application embodying aspects of method and system.

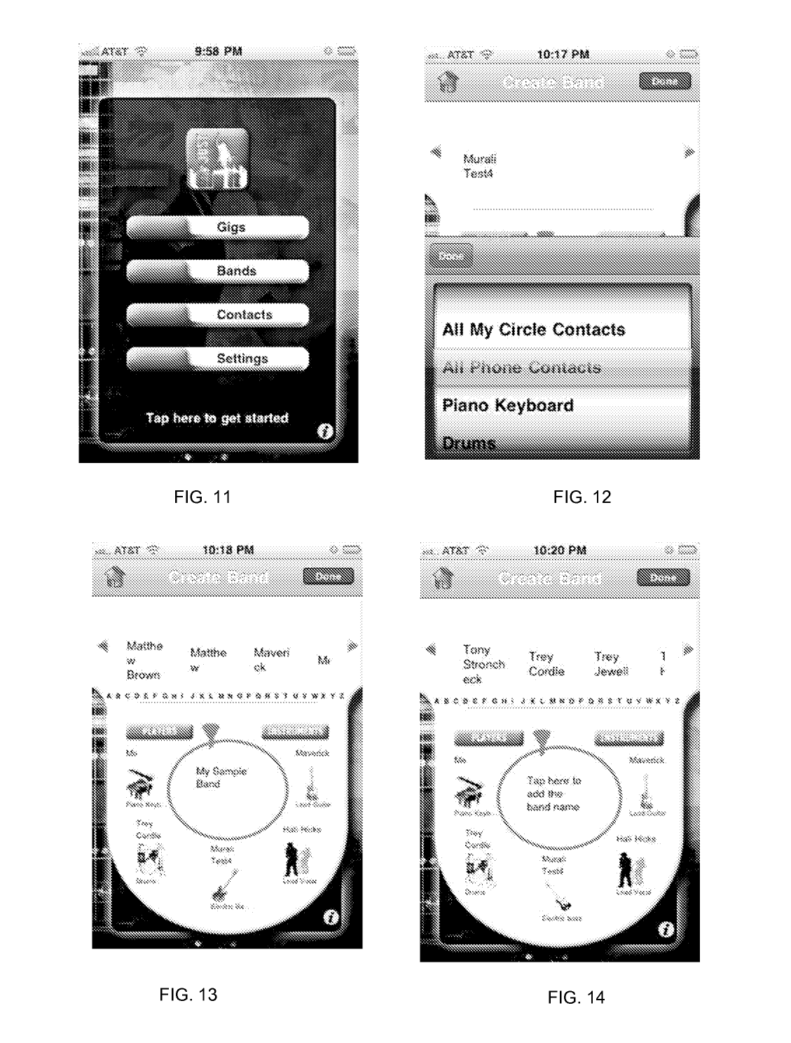

FIGS. 7-10 illustrate exemplary interfaces for entering event (gig) information and finding available performers. FIGS. 11-18 illustrate other sample interface displays for setting up event information, member information, including assembling members to form a band, and adding events.

In one embodiment, the method and system includes a smart phone app, as well as being accessible via social media platforms as well as browser application, that will allow professionals such as musicians to find gigs and find players for their gigs and also expand their social network in the process. This app uses more drag and drop, touch screen features than typing and hence, is very user friendly and fun to use.

The method and system includes contact Circles that allow a musician to organize his contact list into any number of circles, such as inner and outer. These circles represent the confidence of the musician in the contact's skill level. So a contact whose skill level is excellent or professional will be placed in the inner circle and a contact whose skill level is beginner or semi professional or week-end player will be placed in the outer circle. The inner and outer circles are similar to preferred list and second list of professional contacts. In fact, a musician can have many circles such as professional, mid-level, beginner etc. There is another circle called “exclude or do-not-play” list. This list of contacts is those musicians with whom the musician won't like to perform with.

The phone contacts are easily imported into the app based on the musician's choice. In another embodiment, contacts may be additionally imported from other sources, such as from social media platforms by way of example. The musician could also add skills information such as guitar player, drummer etc to the contact when that contact is added to a circle. Further, multiple skills could be added to a contact. For example, a musician could be good at guitar and lead vocals. So for this contact guitar and lead vocal skills are added.

The method and system also allows musicians to create smaller groups of people within their inner circle with whom they like to perform/play regularly. These small groups could be for different types of gigs. A musician might have a band for country type gigs and another one for Jazz type gigs and so on.

The method and system expands the social network. When a musician is looking for a player to play in his gig, the request is sent to all his contacts in his inner circle and their inner circle and their inner circles and so on and so forth. Of course, the musician has to explicitly select the number of layers to send the message. In this process, any musician who is in the exclude circle will not receive the request. This way, the musician is reaching out to other professionals without having to depend on his immediate contacts to push his requests. And the professional that he is reaching out to are of higher quality as they are in the inner (or preferred list) circle of his inner circle contacts—endorsed contacts. Further, this message system excludes the musicians who are: busy during the time of the gig; doesn't have the skill such as guitar, drums etc that the musician is looking for; not physically close by.

Another aspect of the method and system is to provide a single snapshot gig Information: The app provides an easy way to pull all the information of the event into one easy to read screen layout. So, when a gig request goes to a bunch of folks they don't have to ask the gig owner any further information about who is playing in the gig, where is the gig, etc. Further, when players sign up for the gig, the gig page is updated so everyone who is either playing in that gig or who have received requests to play in the gig will see the latest up to date information about the gig.

Further, the gig owner will see who has received the request and whether that person has viewed the request or not or if the person has viewed the request and accepted or rejected the request etc. This transparency in the status of the requests is very important as a musician might be waiting for a particular player as this particular player might be his best choice.

The system provides for real-time notifications to the musicians phones or social media applications when people respond to their requests or when gigs that match their criteria open up or when additional information is added to their gigs. In short, the system sends them notifications when anything related to them changes. So, musicians know what is happening in their professional calendar and don't have to constantly check for emails or updates from others etc.

Any unnecessary or trivial or redundant communication is handled by the system so that the musician doesn't have to waste time. For example, when a musician finds a player to play in his gig, all the other interested players will receive an automated message mentioning that the gig is no longer available. Similarly, if a musician received a request to play in a gig and the musician has not viewed the message until after the actual time of the gig, then the request to play in the gig is removed from the musician's app so that the musician's JGI inbox is not cluttered with irrelevant messages.

The system has an auto match service in built into it. This auto finder will constantly look for gigs that match a musician's gig request or a look for players who might match a player request. When an appropriate match is found, the corresponding members will be notified. This system eliminates the constant reminder texts that musicians have to send each other.

The method and system also provides an event log. Since every gig's information along with who got paid how much etc is saved in the system, at the year-end the system could generate a log of all the gigs played by a particular musician for his tax filing purposes.

Everyone sees the network at their level since the app connects musicians with their trusted friends and their trusted friends and so on. Every musician whether professional or weekend skill level sees this social network as their own. In other words, one of the problems with the public social networks is that different skill level (professional or beginner etc) people will be brought into one homogenous network and so, the quality of the leads is perceived to be inferior. The application gives the control to the member to expand his network in a structured approach—moving from trusted friends to trusted friends and hence, maintains the quality of each individual's network.

The method and system is very flexible and can be applied to not just musicians, but anyone other professional such as standing comedian, sound artist, actor, tv artist, playmaker etc who is looking for a gig. Further, this app can be used by even social groups such as a group of folks playing tennis on weekends.

The advantages of the invention include an expanded social network. The application provides a structured way to expand the social network of the musician and further, helps the musician to manage the social network in one centralized location. Another advantage is finding gigs and finding players for gigs: A core function of the app is matching the players with the gigs. Since the social network used to make this match is based on endorsements, the matching of players with gigs will result in high accuracy and satisfaction. Another advantage is an automatic finder because app can constantly look for gigs for players and vice versa and so, musicians can focus on other important aspect of their professional duties like practice music etc. Another benefit is convenience.

The app offers great convenience through: messages to the musician's app directly; no need for unnecessary or trivial messages; all the information about a gig is latest and up to date; there is no need for resending the same request again and again—automated finder (or matching service); and the biggest convenience is the layout of the app itself—most of the features of the app are drag and drop, touch screen and little typing is needed. Hence, the layout of the app is very user-friendly and convenient.

Another embodiment includes a general calendar. The system keeps one calendar for all the work that the musician is doing and so, easier to book new work. Another embodiment includes the centralized repository. The system keeps track of all the gigs and the payout information so that at the year-end musicians can see a log of their gigs and payouts for tax filing purpose.

In another embodiment, the system can provide for a musician or performer to raise capital to help the musician to produce his music. This can be through the trusted network, whereby other users can donate money, or donate services such as offering to play at a gig for free.

Through the present method and system, improved techniques are provided for managing personnel for events. Members can access a server, provide event information. Based on member data, prospective performers are designated and contacted. Therefore, a central repository accessible via a graphical user interface provides for the coordination of performers for performance events.

FIGS. 1 through 18 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for coordinating personnel for an event, the method comprising:
electronically receiving, at a central processing device, event data relating to an event, the event data including a request for at least one member to participate in the event;
determining a first set of members relating to the event;
providing electronic communication to at least one of the members of the first set of members regarding the event, including a request for participation in the event; and
electronically managing, at the central processing device, the event data including managing member requests for the event.

2. The method of claim 1 further comprising:
accessing a data storage device having a plurality of performer profiles, wherein the performer profiles include profile data about the performers; and
determining the first set of contacts based relationships betweens the event data and profile data.

3. The method of claim 2 further comprising:
culling the first set of members based on exclusionary factors, wherein the exclusionary factors indicate particular members are unable to participate in the event.

4. The method of claim 1, wherein providing electronic communications includes an electronic communication to a mobile computing device.

5. The method of claim 1 further comprising:
receiving, at the central processing device, at least one response from at least one member from the first set of members, the response including an event attendance confirmation; and
updating the event data based on the event attendance confirmation to manage the event data.

6. The method of claim 1, wherein the event is a musical performance and the members are musicians, the event data including a musician type requested for performing at the event, the method further comprising:
determining the first set of members based on the musician type and a trust factor between members.

7. The method of claim 1 further comprising:
electronically receiving member access to the central processing device;
for one or more members, including a trust association with one or more members; and
generating a trust network between the one or more members based on the trust association.

8. The method of claim 7, wherein the determining the first set of members includes being determined based on the trust associations.

9. An event coordinating processing system comprising:
a memory device having executable instructions stored thereon; and
a processing device, in response to the executable instructions, operative to:
receive, at a central processing device, event data relating to an event, the event data including a request for at least one member to participate in the event;
determine a first set of members relating to the event;
provide electronic communication to at least one of the members of the first set of members regarding the event, including a request for participation in the event; and
manage, at the central processing device, the event data including managing member requests for the event.

10. The system of claim 9 further comprising:
a data storage device having a plurality of performer profiles, wherein the performer profiles include profile data about the performers; and
the processing device, in response to further executable instructions, further operative to determine the first set of contacts based relationships betweens the event data and profile data.

11. The system of claim 9, the processing device, in response to further executable instructions, further operative to cull the first set of members based on exclusionary factors, wherein the exclusionary factors indicate particular members are unable to participate in the event.

13. The system of claim 9, the processing device, response to further executable instructions, further operative to:
receive at least one response from at least one member from the first set of members, the response including an event attendance confirmation; and
update the event data based on the event attendance confirmation to manage the event data.

14. The system of claim 9, wherein the event is a musical performance and the members are musicians, the event data including a musician type requested for performing at the event, the processing device, in response to further executable instructions, further operative to:
determine the first set of members based on the musician type and a trust factor between members.

15. The system of claim 14, the processing device, in response to further executable instructions, further operative to:
for one or more members, include a trust association with one or more members; and
generate a trust network between the one or more members based on the trust association.

16. The system of claim 15, wherein the determining the first set of members includes being determined based on the trust associations.

17. A computerized method for coordinating musicians for musical events, the method comprising:
receiving, from a requesting member, event information regarding a musical event, the event data including a request for one or more musicians performing in the musical event;
determining a set of musicians capable of satisfying the request for performing in the musical event;
culling the set of musicians to exclude one or more musicians satisfying one more culling criteria; and
transmitting an electronic communication the remaining set of musicians indicating the musical event and the request for musician performance;

18. The method of claim 17 further comprising:
receiving at least one acceptance by a musician, the acceptance indicating acceptance of performing in the musical event; and
electronically updating, at the central processing device, the event data including managing member requests for the event.

19. The method of claim 17 further comprising:
accessing a data storage device having a plurality of musician profiles, wherein the performer profiles include profile data about the performers; and
culling the set of musicians based at least in part on the profile data.

20. The method of claim 17 further comprising:
for one or more musicians, including a trust association with one or more musicians;
generating a trust network between the one or more musicians based on the trust association; and
determining the first set of musicians includes the trust associations.
